(19) United States
(12) Patent Application Publication
(10) Pub. No.: US 2023/0185115 A1
(43) Pub. Date: Jun. 15, 2023

(54) "M-tech"

(71) Applicant: Donaldo Rex Mitogo, Providence, RI (US)

(72) Inventor: Donaldo Rex Mitogo, Providence, RI (US)

(73) Assignee: Donaldo Rex Mitogo, Providence, RI (US)

(21) Appl. No.: 17/548,553

(22) Filed: Dec. 12, 2021

(51) Int. Cl. G02F 1/01; G02B 30/00; H02J 50/20; B60J 3/04

(52) U.S. Cl. CPC G02F 1/01; G02B 30/00; H02J 50/20; B60J 3/04

(57) ABSTRACT

This device is armored with nanotechnology that allows it to project hologram imagery, touchscreen, and more. This device also comes with 1,000 feet or more of wireless charging distance. A diffuser component that controls the amount of light that passes through a glass, fabric, or material that emits light inside of an object or thing via a door, window, or other points of entry. The device uses digital, analog, laser, and mechanical technologies to control the amount of light that enters inside an object or thing. The features and technological applications will protect the user against skin cancer caused by ultraviolet light, work against the Sun's glare which temporally blinds operators due to extreme sunlight, provide safety and privacy as drivers can change all vehicle's tinted windows from 1% tint to 100% clear glass with a single touch.

### BACKGROUND OF THE INVENTION

### Field of Invention

The M-tech is a cutting-edge technological device designed to eliminate altercations, dangerous traffic stops, unnecessary fines, court visits, and other undesirable citations that spell danger or often result in fatal endings between police officers and private citizens who tint their car's windows. The “M-tech” will also eliminate child cord strangulation by providing a cord-free 1,000 plus feet of wireless charging capability. The majority of people tint their car windows for privacy concerns, medical reasons, glare, UV protection, or for other safety reasons. Even though, the argument opposes that police personnel need to see the interior of the vehicle for public safety reasons, nonetheless, this technological device is exclusively designed to accommodate both parties and for these special circumstances with extended benefits. The M-tech is constructed with sensors, a chip, battery, optical light system, silicon cells, and more. This tiny device can be installed into any object with nanotechnology functionalities allowing the user to change the percentage of light permitted to enter the given object or surface. In addition to that, it is crucial that this device performs the following functionalities, an optical lighting system that performs the digital tint or light diffusion to permit a specific amount of light into the layers of the glass fabric and to block the sunlight accordingly. Sensory projected system; work through the glass to observe touch and send commands to the solid-state-drive chip. Since the glass is always exposed to the sunlight, it is critical to extract the sunlight energy and store it in the silicon cells to be used as the natural energy.

### BRIEF SUMMARY OF THE INVENTION

How does it Work

For the criticality of this invention, it is imperative that the device performs the following functions: a) when the “M-tech” is installed into a vehicle or an object with multiple windows, the windows will be arranged in a numerical format, making the operator's window the main control center, this is made possible due to the device's sensors. The sensors also manage the communication between the user's interface and the software. Ex: if the operator double clicks onto the window, the windows' tint level lowers to 1%; the opposite is true if the operator triple clicks, the window's level elevates to 99% instantaneously. In addition, b) the optic or optical lighting system produces the technology that controls the lighting level, different colors, different shades, and the theme display. Ex: if the “M-tech” is installed into a vehicle's windshield, during sunny days, the “M-tech” will autonomously darken the windshield in order to reduce “glare” and increase visibility, the opposite is true during poor night visions. Including, but not limited to a 3D and 4D live view of the road and the surroundings. The optical lighting system also works in combination with led lighting to output additional brightness, darkness, and different colors. c) The “M-tech” also carries a lithium-ion battery which servers as a power source, in addition to that, there are also silicon cells that observe and store solar, kinetic, thermal, mechanical, and electrical energy. The silicon cells are comprised of semiconductor particles of atoms separating and moving the electrons and protons. The flow of these electrons will then create an electrical charge. The cells will protect the windows against winter frosted windows, snow, heavy rain, and other substances. The device also uses the magnetic field's radio waves and laser beam technology to transport electrons from the transmitter to the receiver in a clearance of 1,000 feet and beyond. The “M-tech” has satellite GPS tags to prevent theft and other technological applications for authenticity and privacy. The wireless connectivity technology of this device will also support cell tower or electron tower to amplify faster charging, unlimited reach per radios, and the social benefit where all users can just plug-in the receiver part onto their devices and no matter where they go, the cell tower or electron tower will send radio waves and laser beams into the receiver component which will turn the bandwidth into electrical pulses which will charge the device.

Benefit Summary

We live in an era where privacy, security, safety, and confidentiality have become our core principles and the most focal point that enriches our freedom and happiness. It is imperative to heed in the close caption the voices of the new generation. A generation where people are willing to sacrifice their financial securities in exchange for a privacy ultimatum. Those who are willing to pay ticket violations, but still tint their cars' windows despite countless traffic stops by police officers. For those who have developed skin cancer due to exposure to ultraviolet light, for the millions of children and pets that die due to vehicular heatstroke, excessive heat that enters the vehicle, and not ignoring fatal road accidents caused by glare and poor visibility.

Therefore, when asked what benefits do the “M-tech” device provides, these are the few problems the device is programmed and created to eliminate. So that when users are stopped by police officers, they can just triple-click their windows and instantaneously clear all the windows thus, creating a friendly and pleasant interaction between both parties. Even eliminate fatal conditions where police officers get nervous and filled with worse case scenarios as they cannot see the driver or the interior of the vehicle. A 1,000+feet of wireless charging clearance allowing users to freely move around and place the device anywhere they wish without the hassle of wire limitations. This wireless application also eliminates the possibilities of death by cord strangulation among children. A cell tower or electro tower that amplifies and strengthen the electron signals to be deposited into the device's receiver box in order to charge universal apparatus wirelessly. This will allow electric cars to run freely and unlimitedly as it will be charged wirelessly autonomously by these towers. This will also allow people with heart devices and other medical devices that keep people alive to never run out of battery and no future surgery needed.

### DESCRIPTION OF RELATED ART

Given the known market, there are known dark fabrics that allow people to tint their vehicles. But these fabrics are usually installed by professionals and cannot be taken down or undo the process by the user. These fabrics are not devices nor pose any social applications. These fabrics are usually dark shades material that people install in their vehicles for tinted windows. Nonetheless, the “M-tech” is truly a cutting-edge technological device built with social applications to serve society by providing privacy, safety, discretion, and more. Another known factor is the publication of wireless charging. The known concept of wireless charging in modern era appears as the practice of putting a device on top of the charging pad and the thermodynamic system moving the electrons within the device's battery, using electromagnetic resonant inductive charging style. Where the created magnetic field creates current inside of the device's coil. The “M-tech” on the other hand, uses a completely different approach, it uses the router like devices or a cell tower signal to charge the device miles away. The likes of a cellular network with radio wave dependency. The “M-tech” has a receiver mounted onto the charging port of the device and the charger attached with a transmitter that sends signal of electron transportation via radio wave and laser beam technology. The “M-tech” has a none-exclusive receiver that can be used to charge other devices. The device comes with an independent charger-head with a transmitter and another attachable piece for the device's receiver.

### DRAWING DESCRIPTION

### Brief Description of the Drawings

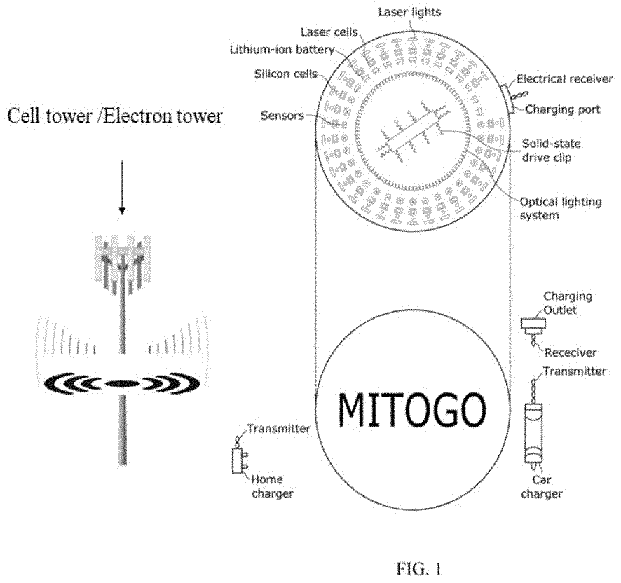

As described above, the components of this device are comprised of LED lights, sensors, silicon cells, laser cells, solid-state-drive chip, lithium-ion battery, wireless charger receiver, wireless charger transmitter, and optical lighting system. These components work in unison. For example, if the “M-tech” is installed into a vehicle's glass window, the sensors will be responsible to register every touch and command and send them to the solid-state drive chip as the user begins to use the device. The silicon cells are responsible for capturing and storing energy, while the laser cells will be making changes of light level and coloring diffusion per angle based on the commands specified by the solid-state drive chip. The solid-state drive chip works as the central processor unit or the command center which holds all of the codes and program's commands. The lithium-ion battery serves as the power source, while the optic or the optical lighting system is responsible for creating the appropriate light and color. In FIG. 1, the inside components of the device are displayed. Inside the device, you will see “LED lights”: designed to expand or diminish the color contrasting systems; reducing or increasing light levels determined by other internal components. A set of “sensors”: for registry, communication, and touch applications. A “silicon cells”: guarded for observing, capturing, and storing different types of energy for later use. A set of “laser cells”: responsible for expending light defusing levels and exact angles for the defused light reachability. A “Lithium-ion battery”: for the device's power supplier. An “optical lighting system”: for creating and coding the exact lighting shade requested by the auto command center or by the user. A “solid-state drive chip”: that holds commands, codes, programs, and more. A “charging port”: designed for the user to mount the wireless receiver. An “electrical receiver”: responsible for receiving electrons to charge the device. An “independent charging outlet”: with an attachable receiver for easy use. Two independent chargers, one for the vehicle, the other for the house with detachable transmitters. In FIG. 1, you will also find a cell tower or electron tower which is responsible for expanding the distribution of electron via radio waves and laser beams which is then converted into electrical pulses to create electricity and charge the device. This tech allows devices to charge autonomously. The transmitters are responsible for sending the electrons to be transported via radio waves and laser beam. A cell tower or electro tower responsible for extending the reachability of the wireless charging technology.

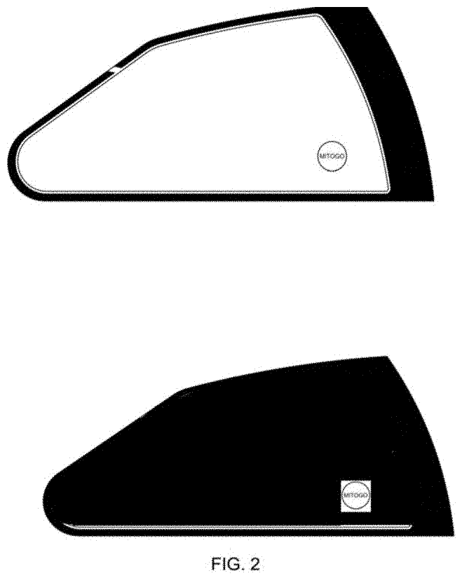

FIG. 2, showcases the “M-tech” device installed into a car's window with 100% visibility and fully tinted window.

What is claimed:

1. An apparatus comprising:
a device that controls the percentage of light entering into an object or surface; wherein the device uses analog, digital, laser, mechanical, and familiar technologies for performance;
the apparatus featuring capabilities of controlling the amount of light or reflection in a glass, fabric, or other material emitting light into an object or surface; wherein the device allows the user to immediately tint, clear or untint their windows; it furthers contains the above qualities, wherein additional functionalities of light contrasting coloring allowing an object or vehicle's window to change into a different set of colors by the user's preference; a software with optical lighting system capable of turning an object or vehicle's window into a luminescent lighting which can be used as a source of light, and the ability of turning a car's window into a black color or transparent at any moment; a device with cell tower signal enhancement capabilities wherein the charging component with the antenna can use cell tower to intensify the reachability of the receiver component; a set of radio wave, laser beam, antenna/receiver, cell tower, and charging components where it all being utilize to expand the bandwidth of the wireless chargeable capabilities.

2. An apparatus comprising:
a device that can be attached onto a surface or object and it uses the object or surface as a holographic touch-pad; an apparatus that can turn a vehicle's windshield, windows, or an object into a holographic 3D visual display, where the user can further use the device's holographic screen to watch a movie or as an infotainment system, that provides audio and video;
an attachable device mounted on an object or placed on a surface wherein the device uses the object as a touchpad; a device that uses the attached surface or surroundings to create and project audio and video, wherein the user can further share content from other devices into the apparatus software via wireless communication such as Bluetooth or Wi-Fi to be displayed in the apparatus' 3D projected hologram video and 4D audio; a device that uses its sensors to darken the driver's windshield when glare is detected during extreme sunny days and converts the windshield into a live 3D display of the road in order to increase road visibility; an independent charging system that uses radio wave and laser beam transmitter and receiver to wirelessly charge a device within 1,000 feet or more distance between the charger and the device; where the charger-head is plugged into an electrical outlet or power source with an attachable transmitter that sends electricity wirelessly into the independent receiver attached into the device using radio wave and laser beam technology; an apparatus that uses fingerprints, facial recognition, and ocular-based security system via the vehicle's window to allow the driver to enter the vehicle once the authenticity verification is successful by locking and unlocking the doors.
